(19) United States
(12) Patent Application Publication
(10) Pub. No.: US 2015/0188131 A1
(43) Pub. Date: Jul. 2, 2015

(54) ACTIVE SUBSTANCE FOR LITHIUM ION SECONDARY CELL AND LITHIUM ION SECONDARY CELL USING SAID ACTIVE SUBSTANCE

(71) Applicant: Panasonic Intellectual Property Management Co., Ltd., Osaka (JP)

(72) Inventors: Toshiro Kume, Hyogo (JP); Takashi Kouzaki, Osaka (JP); Satoru Ohuchi, Osaka (JP); Kazuko Asano, Osaka (JP); Yuta Sugimoto, Osaka (JP); Emiko Igaki, Hyogo (JP)

(73) Assignee: Panasonic Intellectual Property Management Co., Ltd., Osaka (JP)

(21) Appl. No.: 14/406,726

(22) PCT Filed: Dec. 4, 2013
(86) PCT No.: PCT/JP2013/007130

§ 371 Date: Dec. 9, 2014

(30) Foreign Application Priority Data
Apr. 9, 2013 (JP) 2013-081147

(51) Int. Cl. H01M 4/485; H01M 4/58; H01M 10/0525

(52) U.S. Cl. CPC H01M 4/485; H01M 10/0525; H01M 4/5825; H01M 2220/20; H01M 2220/30

(57) ABSTRACT

An active material, for a lithium ion secondary battery, capable of suppressing deposition of lithium metal is provided. The active material for a lithium ion secondary battery has a composition represented by LiZnP₍ₓ₎V₍₁₋ₓ₎O₄ (O<x<1) and having a redox potential that is higher than 0 V and lower than or equal to 1.5 V on a lithium metal basis.

### TECHNICAL FIELD

The present invention relates to an active material for a lithium ion secondary battery, and a lithium ion secondary battery using the same.

### BACKGROUND ART

A lithium ion secondary battery provides a high voltage and has a high energy density, and therefore is expected to be used as a power source of an electronic device, a power storage device or an electric vehicle.

A lithium ion secondary battery includes a positive electrode, a negative electrode, a separator provided between the positive electrode and the negative electrode, and an electrolyte. The separator is formed of, for example, a microporous polyolefin film. The electrolyte may be, for example, a nonaqueous electrolyte such as liquid lithium obtained by dissolving a lithium salt such as LiBF₄, LiPF₆ or the like in a nonprotonic organic solvent. The positive electrode contains a positive electrode active material such as, for example, lithium cobalt oxide (e.g., LiCoO₂) or the like. The negative electrode contains a negative electrode active material formed of any of various carbon materials such as, for example, graphite.

In a lithium ion secondary battery using a carbon material as a negative electrode active material, lithium metal is occasionally deposited on a surface of the negative electrode due to high-rate charge or charge non-uniformity in the electrode. This occurs because the carbon material has a redox potential close to the potential at which the lithium metal is deposited. Such deposition of the lithium metal possibly deteriorates the cycle life (especially when the battery is used at low temperature) and thus is one of problems to be solved by development of a lithium ion secondary battery.

For this reason, negative electrode active materials that are oxidized or reduced at a potential sufficiently higher than the potential at which lithium metal is deposited have been proposed. An example of such negative electrode active materials is Li₄Ti₅O₁₂ (see Patent Document 1) having a working potential of 1.5 V on a lithium metal basis.

### CITATION LIST

### Patent Literature

Patent Document 1: Japanese Patent No. 3502118

### SUMMARY OF INVENTION

### Technical Problem

A non-limiting illustrative embodiment of the present application provides a novel active material capable of suppressing deposition of lithium metal and a lithium ion secondary battery using such an active material.

### Solution to Problem

In order to solve the above-described problems, an embodiment according to the present invention provides an active material that has a composition represented by LiZnP₍ₓ₎V₍₁₋ₓ₎O₄ (0<x<1) and has a redox potential that is higher than 0 V and lower than or equal to 1.5 V on a lithium metal basis.

### Advantageous Effects of Invention

According to an embodiment of the present invention, a novel active material, for a lithium ion secondary battery, capable of suppressing deposition of lithium metal and a lithium ion secondary battery using such an active material are provided.

### BRIEF DESCRIPTION OF DRAWINGS

FIG. 1 is across-sectional view showing an example of lithium ion secondary battery in an embodiment according to the present invention.

FIGS. 2(a) and (b) are respectively model diagrams showing crystal structures, of LiZnPO₄, belonging to space group Cc and space group R3.

FIG. 3 shows x-ray diffraction patterns of active materials in examples and comparative examples before a charge/discharge cycle test.

FIG. 4 shows, in comparison, x-ray diffraction patterns of the active material in comparative example 1 (LiZnVO₄) measured before and after the charge/discharge cycle test.

### DESCRIPTION OF EMBODIMENTS

An overview of an embodiment according to the present invention is as follows.

(1) An active material for a lithium ion secondary battery in an embodiment according to the present invention has a composition represented by LiZnP₍ₓ₎V₍₁₋ₓ₎O₄ (O<x<1) and has a redox potential that is higher than 0 V and lower than or equal to 1.5 V on a lithium metal basis.

(2) The active material described in (1) has a crystal structure in which, for example, a P atom and a V atom share the same site.

(3) The active material described in (1) or (2) is capable of occluding and releasing lithium ions; and the active material has, for example, a crystal structure of a trigonal system, when the lithium ions occluded by the active material are released.

(4) When the lithium ions occluded by the active material described in (3) are released, at least a part of the crystal structure has a space group including, for example, three-fold rotation operation or three-fold rotoinversion operation.

(5) When the lithium ions occluded by the active material described in (3) or (4) are released, at least a part of the crystal structure has a space group of, for example:

R 3̅ or R3. [Expression 1]

(6) x in the composition of the active material described in any one of (1) through (5) fulfills, for example, 0.05≦x≦0.75.

(7) A lithium ion secondary battery in an embodiment according to the present invention includes a positive electrode containing a positive electrode active material capable of occluding and releasing lithium ions; a negative electrode containing an active material of any one of (1) through (6); a separator located between the positive electrode and the negative electrode; and an electrolyte having a lithium ion conductivity.

In this specification, the expression “when the lithium ions occluded by the active material are released” represents the timing when the release of the lithium ions is finished. At this point, lithium ions irreversibly occluded into the active material may be present inside or outside the crystal structure. In, for example, a lithium ion secondary battery using an active material in this embodiment for a negative electrode, “when the lithium ions occluded by the active material are released” represents the state when discharge is finished.

### EMBODIMENTS

Hereinafter, an active material in an embodiment according to the present invention will be described. The active material in this embodiment is capable of occluding and releasing lithium ions, and is usable as, for example, a negative electrode active material for a lithium ion secondary battery.

The active material in this embodiment has a composition represented by LiZnP₍ₓ₎V₍₁₋ₓ₎O₄ (O<x<1). The redox potential Vc of the active material on a lithium metal basis (hereinafter, referred to simply as “active material redox potential Vc”) is higher than 0 V and lower than or equal to 1.5 V.

The active material in this embodiment has an active material redox potential Vc that is higher than 0 V, and therefore can suppress lithium metal from being deposited. The active material in this embodiment also has an active material redox potential Vc that is lower than or equal to 1.5 V, and therefore can guarantee that the voltage between the positive electrode and the negative electrode has a certain level and suppress the energy density from being decreased. Therefore, use of the active material in this embodiment realizes a lithium ion secondary battery which is capable of suppressing lithium metal from being deposited and has a high energy density. In addition, the crystal breakage of the active material, which would be caused by repeated charge/discharge, is suppressed as described later. Therefore, a high reliability is provided. The active material in this embodiment may contain another active material substance as well as the active material substance having the above-described composition. For example, the active material in this embodiment may be a mixture of an active material substance having the above-described composition and another active material substance.

In this embodiment, the active material redox potential Vc is preferably higher than or equal to 0.5 V. With such a range of active material redox potential Vc, lithium metal can be suppressed from being deposited more effectively. When the active material redox potential Vc is excessively higher than that of a graphite-based active material substance, the voltage between the positive electrode and the negative electrode is decreased, which may undesirably decrease the energy density to a level lower than that of the conventional lithium ion secondary battery. In order to suppress the decrease in the energy density with certainty, the active material redox potential Vc in this embodiment is preferably lower than 1.5 V, and more preferably lower than 1.0 V.

Hereinafter, an active material in this embodiment having the composition (LiZnP₍ₓ₎V₍₁₋ₓ₎O₄ (O<x<1)) will be described in more detail.

<Composition of an Active Material: LiZnP₍ₓ₎V₍₁₋ₓ₎O₄ (O<x<1)>

In a crystal structure of an active material having the above-described composition, a P (phosphorus) atom and a V (vanadium) atom may share the same site. The occupation ratio of the shared site, namely, P:V is x:1-x. In such a structure, the breakage of the crystal structure, which would be caused due to desorption/insertion (desorption and insertion) of lithium ions at the time of charge/discharge, can be suppressed by controlling x in the composition formula as described later. As a result, the reliability of the lithium ion secondary battery can be further raised.

The active material may have a crystal structure of a trigonal system. In this case, at least a part of the crystal structure may have a space group including three-fold rotoinversion operation or three-fold rotation operation. For example, the space group (Hermann-Mauguin notation) may be:

R 3̅ (hereinafter, represented as “R-3”), or R3. [Expression 2]

In such a crystal structure, a tunnel-like gap is formed in the crystal. Therefore, desorption/insertion of lithium ions from/to the gap can be performed efficiently at the time of charge/discharge. This realizes a high charge/discharge efficiency. The active material in this embodiment includes a crystal phase in which the space group includes three-fold rotoinversion operation or three-fold rotation operation, and may further include another crystal phase. It should be noted that a more conspicuous effect is provided in the case where the active material is mainly formed of a crystal phase including three-fold rotoinversion operation or three-fold rotation operation. The active material in this embodiment may include a crystal phase having a space group that includes three-fold rotoinversion operation (e.g., space group R-3) and a crystal phase having a space group that includes three-fold symmetry operation (e.g., space group R3) in a mixed state.

In this specification, a “crystal structure” of an active material (or crystal phase) is a crystal structure in the state where lithium ions occluded by the active material are released.

In the composition formula of the active material, x may fulfill 0.05≦x≦0.75. As described later in detail, when x is larger than or equal to 0.05, the breakage of the crystal structure, which would be caused by repeated desorption/insertion of lithium ions, can be suppressed more effectively. By contrast, when x is smaller than or equal to 0.75, the gap for desorption/insertion of lithium ions can be obtained with more certainty. Therefore, the charge/discharge cycle characteristics of the lithium ion secondary battery can be improved and the reliability thereof can be effectively raised.

<Crystal Structure of an Active Material>

The crystal structure of an active material in this embodiment will be described regarding the case where x in the above composition formula is 1, namely, regarding the crystal structure of LiZnPO₄.

In the case where the active material is represented by LiZnPO₄, the crystal structure thereof may be of a trigonal system or a monoclinic system. In the case of the trigonal system, at least a part of the crystal structure may have a space group including three-fold rotation operation, for example, a space group R3. In the case where the space group includes three-fold rotation operation, a gap suitable for desorption/insertion of lithium ions is contained in the crystal as described above. This can improve the charge/discharge efficiency. In the case where the crystal structure of LiZnPO₄ is of a monoclinic system, at least a part of the crystal structure may have a space group Cc. The space group Cc includes glide reflection operation but does not include three-fold rotation operation or three-fold rotoinversion operation. Even in such a structure, a gap for desorption/insertion of lithium ions is contained in the crystal with certainty.

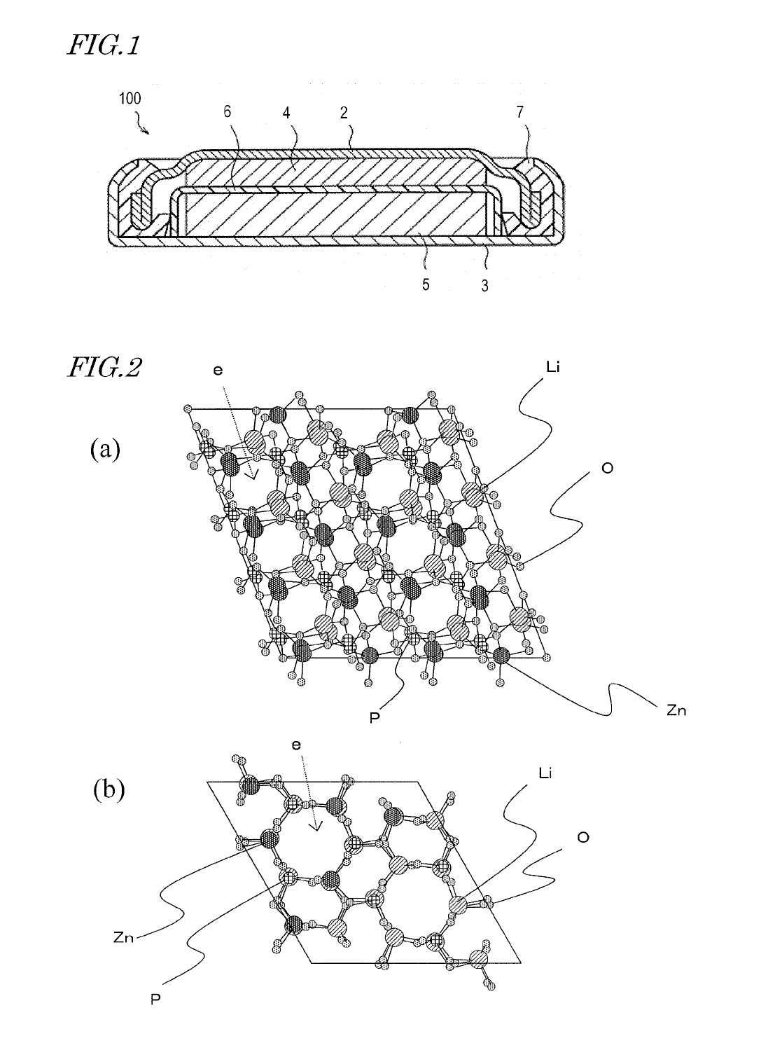

FIGS. 2(a) and (b) are each a model diagram showing a crystal structure of LiZnPO₄, which is a reference example. FIG. 2(a) shows an example of structure belonging to the space group Cc (hereinafter, referred to as the “Cc structure”), and FIG. 2(b) shows an example of structure in which the space group includes three-fold rotation operation (hereinafter, referred to as the “R3 structure”).

The active material in this embodiment (LiZnP₍ₓ₎V₍₁₋ₓ₎O₄ (0<x<1)) has, for example, a crystal structure (R3 structure) in which a part of the P atoms in the R3 structure shown in FIG. 2(b) is substituted with V atoms.

As can be seen from FIGS. 2(a) and (b), a crystal having each of the Cc structure and the R3 structure contains a gap e for desorption/insertion of lithium ions. The R3 structure is considered to allow lithium ions to be desorbed/inserted more efficiently than the Cc structure although this depends on the size of the gap e. Although not shown, a structure including three-fold rotoinversion operation (R-3 structure) also allows lithium ions to be desorbed/inserted efficiently, like the R3 structure.

Now, the knowledge obtained by the present inventors regarding the relationship between the value of x in the composition formula of the active material, LiZnP₍ₓ₎V₍₁₋ₓ₎O₄, and the stability of the crystal structure will be explained.

The present inventor first examined LiZnVO₄ (where x in the composition formula is 0). The crystal structure of LiZnVO₄ is an R3 structure (see FIG. 2(b)) or an R-3 structure and is considered to have a gap e for desorption/insertion of lithium ions formed therein. However, the following has been found: in a lithium ion secondary battery produced by use of LiZnVO₄ as a negative electrode active material, the crystal structure of the negative electrode active material may possibly be broken along with charge/discharge, which may decrease the capacitance. A presumed reason for this is that the crystal of LiZnVO₄ has a large lattice constant and thus the crystal structure is unstable. Thus, the present inventor continued the examination with an assumption that the crystal structure might be stabilized with a smaller lattice constant of the crystal structure and a shorter distance between adjacent atoms. As a result, the following knowledge was obtained: in the state where a part of (or the entirety of) the V atoms in the crystal structure of LiZnVO₄ has been substituted with P atoms, the lattice constant of the crystal is controlled and thus the decrease in the capacitance, which would be caused by the crystal breakage, is suppressed. Specifically, as the substitution ratio of the V atoms with the P atoms is higher, the lattice constant is smaller and thus the breakage of the crystal structure, which would be caused by repeated charge/discharge (desorption/insertion of lithium ions) is suppressed more effectively. By contrast, it is considered that as the substitution ratio is lower, the gap e is larger and thus the desorption/insertion of the lithium ions occurs more easily. Based on this knowledge, the substitution ratio of the V atoms with the P atoms (i.e., the value of x in the composition formula) is controlled in accordance with the structure or the use of the lithium ion secondary battery, so that an active material that is more reliable than the conventional active material is obtained.

<Method for Producing an Active Material>

Now, an example of method for producing an active material in this embodiment will be described.

For producing an active material in this embodiment, the following substances are usable. Examples of substances usable as a lithium material include lithium compounds such as lithium hydroxide, lithium carbonate, lithium oxide and the like. Examples of substances usable as a zinc material include zinc oxide, zinc carbonate and the like. Examples of substances usable as a phosphorus material include diammonium hydrogen phosphate, ammonium dihydrogen phosphate and the like. Examples of substances usable as a vanadium material include vanadium oxide (V). Each of these materials may be formed of one compound or a combination of two or more compounds.

An active material in this embodiment (LiZnP₍ₓ₎V₍₁₋ₓ₎O₄) is produced by, for example, pulverizing and mixing the above-described materials and baking the resultant mixture in an air atmosphere. The baking temperature is set to, for example, higher than or equal to 500° C. and lower than or equal to 750° C., preferably higher than or equal to 600° C. and lower than or equal to 700° C. When the baking temperature is too low, the reactivity is decreased and thus the baking needs to be performed for a long time in order to produce a single phase. When the baking temperature is too high, the production cost is increased, and crystallinity may possibly be lost because the mixture under baking may be melted.

The method for producing the active material is not limited to the above method. Instead of the above method, any of various synthesis methods including hydrothermal synthesis, supercritical synthesis, co-precipitation and the like is usable.

<Structure of a Lithium Ion Secondary Battery>

Now, a structure of a lithium ion secondary battery using an active material in this embodiment will be described. In this embodiment, it is merely needed that one of the electrodes of the lithium ion secondary battery contains the above-described active material, and there is no other specific limitation on the structure of the battery.

A lithium ion secondary battery includes a negative electrode containing the above-described active material as a negative electrode active material, a positive electrode containing an active material capable of occluding and releasing lithium ions (positive electrode active material), a separator located between the positive electrode and the negative electrode, and an electrolyte having a lithium ion conductivity.

The negative electrode includes a negative electrode current collector and a negative electrode mix supported by the negative electrode current collector. The negative electrode mix contains the above-described active material (LiZnP₍ₓ₎V₍₁₋ₓ₎O₄ (O<x<1)). In addition to this active material, the negative electrode mix may contain any other active material, a binder, a conductor or the like. The negative electrode may be produced by, for example, mixing the negative electrode mix with a liquid component to prepare a negative electrode mix slurry, applying the resultant slurry onto the negative electrode current collector, and drying the slurry.

Preferably, a binder and a conductive additive are contained in the negative electrode at the following ratio with respect to the active material (negative electrode active material). With respect to 100 parts by weight of the negative electrode active material, the binder is contained at a ratio in the range higher than or equal to 1 part by weight and lower than or equal to 20 parts by weight, and the conductive additive is contained at a ratio in the range higher than or equal to 1 part by weight and lower than or equal to 25 parts by weight.

The negative electrode current collector is formed of, for example, stainless steel, nickel, copper or the like. There is no specific limitation on the thickness of the negative electrode current collector. The thickness of the negative electrode current collector is preferably 1 to 100 μm, and more preferably 5 to 20 μm. The thickness of the negative electrode current collector is set to the above-described range, so that the electrode plate is kept sufficiently strong while being lightweight.

The positive electrode includes a positive electrode current collector and a positive electrode mix supported by the positive electrode current collector. The positive electrode mix may contain a positive electrode active material, a binder, a conductor or the like. The positive electrode may be produced by, for example, mixing the positive electrode mix with a liquid component to prepare a positive electrode mix slurry, applying the resultant slurry onto the positive electrode current collector, and drying the slurry.

Examples of substances usable as a positive electrode active material include composite oxides such as lithium cobalt oxide and denatured materials thereof (e.g., eutectics with aluminum or magnesium), lithium nickel oxide and denatured materials thereof (e.g., materials having a part of nickel being substituted with cobalt or manganese), and lithium manganese oxide and denatured materials thereof; lithium iron phosphate and denatured materials thereof; lithium manganese phosphate and denatured materials thereof; and the like. The positive electrode active material may be formed of one material or a combination of two or more materials.

Examples of substances usable as a binder for a positive electrode or a negative electrode include PVDF, polytetrafluoroethylene, polyethylene, polypropylene, aramid resin, polyamide, polyimide, polyamideimide, polyacrylonitrile, polyacrylic acid, poly(methylester acrylate), poly(ethylester acrylate), poly(hexylester acrylate), polymethacrylic acid, poly(methylester methacrylate), poly(ethylester methacrylate), poly(hexylester methacrylate), poly(vinyl acetate), polyvinylpyrrolidone, polyether, polyethersulfone, hexafluoropolypropylene, styrene butadiene rubber, carboxymethylcellulose, and the like. A copolymer of two or more materials selected from tetrafluoroethylene, hexafluoroethylene, hexafluoropropylene, perfluoroalkylvinylether, vinylidene fluoride, chlorotrifluoroethylene, ethylene, propylene, pentafluoropropylene, fluoromethylvinylether, acrylic acid, and hexadiene may also be used. A mixture of two or more selected from these materials may be used. Examples of substances usable as a conductor to be incorporated into the electrode include graphites such as natural graphite, artificial graphite and the like; carbon black materials such as acetylene black, Ketjen black, channel black, furnace black, lamp black, thermal black and the like; conductive fibers such as carbon fiber, metal fiber and the like; metal powder materials such as carbon fluoride, aluminum and the like; conductive whisker materials such as zinc oxide, potassium titanate and the like; conductive metal oxides such as titanium oxide and the like; organic conductive materials such as phenylene derivative and the like; etc.

Preferably, a binder and a conductive additive are contained in the positive electrode at the following ratio with respect to the positive electrode active material. With respect to 100 parts by weight of the positive electrode active material, the binder is contained at a ratio in the range higher than or equal to 1 part by weight and lower than or equal to 20 parts by weight, and the conductive additive is contained at a ratio in the range higher than or equal to 1 part by weight and lower than or equal to 25 parts by weight.

The positive electrode current collector is formed of, for example, stainless steel, aluminum, titanium or the like. There is no specific limitation on the thickness of the positive electrode current collector. The thickness of the positive electrode current collector is preferably 1 to 100 μm, and more preferably 5 to 20 μm. The thickness of the positive electrode current collector is set to the above-described range, so that the electrode plate is kept sufficiently strong while being lightweight.

The separator located between the positive electrode and negative electrode is formed of, for example, microporous thin film, woven cloth, nonwoven cloth or the like which has a sufficient ion permeability, a predetermined mechanical strength and a predetermined insulation property. The microporous thin film may be a composite film or a multiple layer film formed of one material or two or more materials. The separator may be formed of, for example, polyolefin such as polypropylene, polyethylene or the like. Polyolefin has a high durability and a shutdown function, and therefore raises the reliability of the lithium ion secondary battery. The separator has a thickness of, for example, 10 to 300 μm, preferably 10 to 40 μm, and more preferably 10 to 25 μm. The separator has a porosity that is preferably in the range of 30 to 70%, and more preferably in the range of 35 to 60%. The “porosity” refers to the volumetric ratio of pores (gaps) with respect to the entire separator.

A substance usable as an electrolytic solution may be liquid, gelatinous or solid (polymeric solid electrolyte).

A liquid nonaqueous electrolyte (nonaqueous electrolytic solution) is produced by dissolving an electrolyte (e.g., lithium salt) in a nonaqueous solvent. A gelatinous nonaqueous electrolyte contains a nonaqueous electrolyte and a polymeric material that retains the electrolyte. Examples of usable polymeric materials include polyvinylidene difluoride, polyacrylonitrile, poly(ethylene oxide), poly(vinyl chloride), polyacrylate, poly(vinylidene fluoride-hexafluoropropylene), and the like.

As a nonaqueous solvent in which the electrolyte is to be dissolved, a known nonaqueous solvent is usable. There is no specific limitation on the type of the nonaqueous solvent. The nonaqueous solvent may be, for example, cyclic carbonate ester, chain carbonate ester, cyclic carboxylate ester or the like. Examples of the cyclic carbonate ester include propylene carbonate (PC), ethylene carbonate (EC) and the like. Examples of the chain carbonate ester include diethyl carbonate (DEC), ethylmethylcarbonate (EMC), dimethyl carbonate (DMC) and the like. Examples of the cyclic carboxylate ester include γ-butyrolactone (GBL), γ-valerolactone (GVL) and the like. The nonaqueous solvent may be formed of one material or a combination of two or more materials.

Examples of substances usable as the electrolyte to be dissolved in the nonaqueous solvent include LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lower aliphatic lithium carboxylate, LiCl, LiBr, LiI, chloro borane lithium, borate, imidate, and the like. Examples of the borate include lithium bis(1,2-benzenediolate(2-)-O,O′) borate, lithium bis(2,3-naphthalenediolate(2-)-O,O′) borate, lithium bis(2,2-biphenyldiolate(2-)-O,O′) borate, lithium bis(5-fluoro-2-olate-1-benzenesulfonic acid-O,O′) borate, and the like. Examples of the imidate include lithium bis(trifluoromethanesulfonyl)imide ((CF₃SO₂)₂NLi), lithium trifluoromethanesulfonyl nonafluorobutanesulfonyl imide (LiN(CF₃SO₂)(C₄F₉SO₂)), and lithium bis(pentafluoroethanesulfonyl)imide ((C₂F₅SO₂)₂NLi), and the like. The electrolyte may be formed of one material or a combination of two or more materials.

The nonaqueous electrolytic solution may contain, as an additive, a material that is decomposed on a negative electrode to form a film having a high lithium ion conductivity and thus can increase the charge/discharge efficiency. Examples of additives having such a function include vinylidenecarbonate (VC), 4-methylvinylidenecarbonate, 4,5-dimethylvinylidenecarbonate, 4-ethylvinylidenecarbonate, 4,5-diethylvinylidenecarbonate, 4-propylvinylidenecarbonate, 4,5-dipropylvinylidenecarbonate, 4-phenylvinylidenecarbonate, 4,5-diphenylvinylidenecarbonate, vinylethylenecarbonate (VEC), divinylethylenecarbonate and the like. These materials may be used independently or in a combination of two or more thereof. Among these materials, at least one selected from the group consisting of vinylidenecarbonate, vinylethylenecarbonate and divinylethylenecarbonate is preferable. The above-listed compounds may each have a part of hydrogen atoms substituted with fluorine atoms. The electrolyte is preferably dissolved in an amount in the range of 0.5 to 2.0 mol/L with respect to the nonaqueous solvent.

The nonaqueous electrolytic solution may contain a known benzene derivative that is decomposed at the time of overcharge to form a film on the electrode and thus inactivates the battery. Such a benzene derivative may contain a phenyl group and a cyclic compound group adjacent to the phenyl group. The cyclic compound group may be a phenyl group, a cyclic ether group, a cyclic ester group, a cycloalkyl group, a phenoxy group or the like. Specific examples of the benzene derivative include cyclohexylbenzene, biphenyl, diphenylether and the like. These materials may be used independently or in a combination of two or more thereof. It is preferable that the content of the benzene derivative is lower than or equal to 10% by volume with respect to the entire nonaqueous solvent.

FIG. 1 is a schematic cross-sectional view showing an example of a coin-shaped lithium ion secondary battery 100.

The lithium ion secondary battery 100 includes an electrode group including a negative electrode 4, a positive electrode 5 and a separator 6. The negative electrode 4 and the positive electrode 5 are located such that a negative electrode mix and a positive electrode mix face each other. The separator 6 is located between the negative electrode 4 and the positive electrode 5 (between the negative electrode mix and the positive electrode mix). The battery group is impregnated with an electrolyte (not shown) having a lithium ion conductivity. The positive electrode 5 is electrically connected to a battery case 3 also acting as a positive electrode terminal, and the negative electrode 4 is electrically connected to a sealing plate 2 also acting as a negative electrode terminal. An open end of the battery case 3 is caulked with a gasket 7 provided along a perimeter of the sealing plate 2, so that the battery is entirely sealed. FIG. 1 shows an example of a coin-shaped battery. The lithium ion secondary battery in this embodiment is not limited to being coin-shaped, and may be button-shaped, sheet-like, cylindrical, flat, polygonal or the like.

### Examples and Comparative Examples

Active materials in examples and comparative examples were produced and evaluated. Hereinafter, the production methods and the evaluation results will be described.

### (i) Production of Active Materials

### Example 1

3.69 g of Li₂CO₃, 8.14 g of ZnO, 8.64 g of V₂O₅, and 0.66 g of (NH₄)₂HPO₄ were fully mixed in a sardonyx mortar. The resultant mixture was reacted in an air atmosphere at a temperature of 615° C. for 12 hours to obtain active material a1 having a composition represented by LiZnP_{0.05}V_{0.95}O₄.

Next, active material a1 was analyzed by use of x-ray diffraction (XRD). Based on the measurement results obtained by the XRD, the d values (lattice spacings, Å) and the mirror indices of peaks shown in Table 1 below were obtained. From these results, it has been confirmed that active material a1 is of a trigonal system and includes a phase in which the space group includes three-fold rotation operation or three-fold rotoinversion operation.

### Example 2

3.69 g of Li₂CO₃, 8.14 g of ZnO, 4.55 g of V₂O₅, and 6.60 g of (NH₄)₂HPO₄ were fully mixed in a sardonyx mortar. The resultant mixture was reacted in an air atmosphere at a temperature of 615° C. for 12 hours to obtain active material a2 having a composition represented by LiZnP_{0.5}V_{0.5}O₄.

Active material a2 was analyzed by use of XRD. Based on the measurement results, the d values (lattice spacings, Å) and the mirror indices of peaks shown in Table 1 below were obtained. From these results, it has been confirmed that active material a2 is of a trigonal system and includes a phase in which the space group includes three-fold rotation operation or three-fold rotoinversion operation.

### Example 3

3.69 g of Li₂CO₃, 8.14 g of ZnO, 2.27 g of V₂O₅, and 9.90 g of (NH₄)₂HPO₄ were fully mixed in a sardonyx mortar. The resultant mixture was reacted in an air atmosphere at a temperature of 615° C. for 12 hours to obtain active material a3 having a composition represented by LiZnP_{0.75}V_{0.25}O₄.

Active material a3 was analyzed by use of XRD. Based on the measurement results, the d values (lattice spacings, Å) and the mirror indices of peaks shown in Table 1 below were obtained. From these results, it has been confirmed that active material a3 is of a trigonal system and includes a phase in which the space group includes three-fold rotation operation or three-fold rotoinversion operation.

### Comparative example 1

3.69 g of Li₂CO₃, 8.13 g of ZnO, and 9.08 g of V₂O₅ were fully mixed in a sardonyx mortar. The resultant mixture was reacted in an air atmosphere at a temperature of 615° C. for 12 hours to obtain active material c1 having a composition represented by LiZnVO₄.

Active material c1 was analyzed by use of XRD. Based on the measurement results, the d values (lattice spacings, Å) and the mirror indices of peaks shown in Table 1 below were obtained. From these results, it has been found that active material c1 is of a trigonal system and includes a phase in which the space group includes three-fold rotation operation.

### Comparative example 2

3.69 g of Li₂CO₃, 8.14 g of ZnO, and 13.21 g of (NH₄)₂HPO₄ were fully mixed in a sardonyx mortar. The resultant mixture was reacted in an air atmosphere at a temperature of 615° C. for 12 hours to obtain active material c2 having a composition represented by LiZnPO₄.

Active material c2 was analyzed by use of XRD. Based on the measurement results, the d values (lattice spacings, Å) and the mirror indices of peaks shown in Table 1 below were obtained. From these results, it has been found that active material c2 is of a monoclinic system and includes a phase in which the space group does not include three-fold rotation operation or three-fold rotoinversion operation.

TABLE 1

| Active | | Lattice spacing | Mirror index | | |
|---|---|---|---|---|---|
| material | Composition | (Å) | h | k | l |
| a1 | LiZnP_{0.05}V_{0.95}O₄ | 4.1526 | 2 | 1 | 1 |
| | | 4.0773 | 3 | 0 | 0 |
| | | 3.5337 | 2 | 2 | 0 |
| | | 2.8797 | 1 | 1 | 3 |
| | | 2.6734 | 4 | 1 | 0 |
| | | 2.3546 | 2 | 2 | 3 |
| | | 1.8897 | 3 | 3 | 3 |
| | | 1.4449 | 7 | 1 | 3 |
| | | 1.3884 | 6 | 3 | 3 |
| a2 | LiZnP_{0.5}V_{0.5}O₄ | 4.0996 | 2 | 1 | 1 |
| | | 4.0298 | 3 | 0 | 0 |
| | | 3.4874 | 2 | 2 | 0 |
| | | 2.8377 | 1 | 1 | 3 |
| | | 2.6316 | 4 | 1 | 0 |
| | | 2.3167 | 2 | 2 | 3 |
| | | 1.8567 | 3 | 3 | 3 |
| | | 1.4173 | 7 | 1 | 3 |
| | | 1.3901 | 6 | 3 | 3 |
| a3 | LiZnP_{0.75}V_{0.25}O₄ | 4.0698 | 2 | 1 | 1 |
| | | 4.0266 | 3 | 0 | 0 |
| | | 3.4773 | 2 | 2 | 0 |
| | | 2.8290 | 1 | 1 | 3 |
| | | 2.6270 | 4 | 1 | 0 |
| | | 2.3110 | 2 | 2 | 3 |
| | | 1.8525 | 3 | 3 | 3 |
| | | 1.4135 | 7 | 1 | 3 |
| | | 1.3582 | 6 | 3 | 3 |
| c1 | LiZnVO₄ | 4.1913 | 2 | 1 | 1 |
| | | 4.1149 | 3 | 0 | 0 |
| | | 3.5592 | 2 | 2 | 0 |
| | | 2.8988 | 1 | 1 | 3 |
| | | 2.6898 | 4 | 1 | 0 |
| | | 2.3672 | 2 | 2 | 3 |
| | | 1.8982 | 3 | 3 | 3 |
| | | 1.4495 | 7 | 1 | 3 |
| | | 1.3923 | 6 | 3 | 3 |
| c2 | LiZnPO₄ | 4.2284 | 2 | 2 | −1 |
| | | 4.1659 | 2 | 2 | 0 |
| | | 4.0156 | 4 | 0 | 0 |
| | | 3.9899 | 0 | 0 | 4 |
| | | 3.8675 | 2 | 2 | 1 |
| | | 3.6236 | 2 | 2 | −3 |
| | | 3.5360 | 4 | 0 | −4 |
| | | 3.4474 | 2 | 2 | 2 |
| | | 3.2325 | 5 | 1 | −2 |
| | | 3.1902 | 2 | 2 | −4 |

### (ii) Lattice Constants of the Active Materials

Based on the d values and the mirror indices of the peaks shown in Table 1, the lattice constants of each of the active materials a1 through a3, c1 and c2 in examples 1 through 3 and comparative examples 1 and 2 were calculated. Table 2 shows the results.

TABLE 2

| Active | Active material | Lattice constant | | |
|---|---|---|---|---|
| material | composition | a axis(Å) | b axis(Å) | c axis(Å) |
| a1 | LiZnP_{0.05}V_{0.95}O₄ | 14.163 | — | 9.475 |
| a2 | LiZnP_{0.5}V_{0.5}O₄ | 13.857 | — | 9.280 |
| a3 | LiZnP_{0.75}V_{0.25}O₄ | 13.837 | — | 9.217 |
| c1 | LiZnVO₄ | 14.178 | — | 9.483 |
| c2 | LiZnPO₄ | 17.229 | 9.759 | 17.094 |

From Table 2, it has been found that with active materials a1 through a3 of the trigonal system, as the value of x in the composition formula is larger, namely, the ratio of the P atoms is higher, the lattice constant is smaller.

FIG. 3 shows x-ray diffraction patterns obtained by XRD for active materials a1 through a3 and c1 of the trigonal system. In FIG. 3, the peak of the x-ray diffraction pattern of each active material is attributed to the mirror index (410) of LiZnP₍ₓ₎V₍₁₋ₓ₎O₄.

As can be seen from FIG. 3, the peak of active material c1 appears at the lowest angle (2θ), and the angle of the peak is increased in the order of active materials a1, a2 and a3. Thus, it has been confirmed that as the ratio of the V atoms in the crystal substituted with the P atoms (ratio of substation with the P atoms) is higher, the peak is shifted toward the wide angle side (direction of the arrow in FIG. 3) and the lattice constant is smaller.

### (iii) Production of Electrodes

Electrodes in the examples and the comparative examples were produced by use of active materials a1 through a3, c1 and c2 obtained above. The production method will be described.

One hundred parts by weight of each of the above-described active materials, 10 parts by weight of acetylene black as a conductor, 10 parts by weight of poloyvinylidene difluoride as a binder, and an appropriate amount of N-methyl-2-pyrrolidone (NMP) solution as a dispersant were mixed to prepare a mix paste.

The mix paste was applied to a surface of a current collector and dried to form an active material layer. As the current collector, a copper foil having a thickness of 18 μm was used. Next, the current collector having the active material layer formed thereon was subjected to flat press at a weight of 2 tons/cm² to be compressed until the total thickness of the current collector and the active material layer became 100 μm. Then, the current collector having the active material layer formed thereon was punched into a circle having a diameter of 12.5 mm. Thus, an electrode was produced.

### (iv) Production of Counter Electrodes

Lithium foils having a thickness of 300 μm were each punched into a circle having a diameter of 14.5 mm. The resultant circular foils were each to be used as a counter electrode.

### (v) Preparation of a Nonaqueous Electrolyte

LiPF₆ as a solute was dissolved at a concentration of 1.0 mol/L in a mixture solvent containing ethylenecarbonate and ethylmethylcarbonate at a volumetric ratio of 1:3. Thus, a nonaqueous electrolyte was produced.

### (vi) Production of Evaluation Cells

Evaluation cells having the above-described structure were produced with reference to FIG. 1, by use of, respectively, the electrodes produced by use of active materials a1 through a3, c1 and c2 as negative electrodes.

FIG. 1 is now referred to again. For each evaluation cell, a stainless steel plate resistant against an organic electrolytic solution was processed to form the battery case 2 and the sealing plate 3. As the negative electrode 4, any one of the electrodes in the examples and the comparative examples was used. As the positive electrode 5, the above-described counter electrode (metallic lithium) was used. For the evaluation cell, a part of the battery case 3 was caused to act as a positive electrode current collector. As the separator 6 and the gasket 7, a microporous polypropylene separator and a polypropylene resin insulating gasket were used respectively.

In each of the examples and the comparative examples, the counter electrode (metallic lithium) was spot-welded to an inner surface of the battery case 3 to form the positive electrode 5. Next, the separator 6 was located on the positive electrode 5, and the nonaqueous electrolyte was put into a space enclosed by the battery case 3 and the separator 6. Meanwhile, any one of the above-produced electrodes as the negative electrode 4 was put into pressure-contact with an inner surface of the sealing plate 2. Then, the sealing plate 2 having the negative electrode 4 pressure-contacted thereto was fit into the opening of the battery case 3 via the gasket 7 to seal the battery case 3. Thus, a coin-shaped evaluation cell was produced. Evaluation cells using active materials a1 through a3, c1 and c2 will be respectively referred to as evaluation cells A1 through A3, C1 and C2.

### (vii) Evaluation of Charge/Discharge Characteristics

A charge/discharge cycle test was performed on each of evaluation cells A1 through A3, C1 and C2, and charge/discharge characteristics thereof were measured.

The charge/discharge cycle test was performed as follows. The cycle of charging the cell at a constant current of 0.1 mA until the voltage reached 0.7 V and then discharging the cell at a constant current of 0.1 mA until the voltage reached 2.5 V in room environments was repeated 10 times. The discharge capacitance at the second cycle, the average charge potential Vc on a lithium metal basis at the second cycle, and the coulombic efficiency (discharge capacitance/charge capacitance) at the tenth cycle were measured. The discharge capacitance and the coulombic efficiency tend to be decreased when the active material is deteriorated, for example, the crystal breakage of the active material occurs. Therefore, the measured values of the discharge capacitance and the coulombic efficiency were used as indices for determining the degree of crystal breakage of each active material.

Table 3 shows the measurement results of the charge/discharge characteristics.

TABLE 3

| | | | Average | |
|---|---|---|---|---|
| | | | charge | |
| | | | potential of | |
| | | Discharge | the negative | |
| | | capacitance | electrode on | |
| | Active | at the 2nd | the basis of | Coulombic |
| Evaluation | material | cycle | Li metal | efficiency |
| cell | composition | (mAh) | Vc (V) | (%) |
| A1 | LiZnP_{0.05}V_{0.95}O₄ | 1.45 | 1.20 | 96.9 |
| A2 | LiZnP_{0.5}V_{0.5}O₄ | 2.28 | 1.18 | 96.0 |
| A3 | LiZnP_{0.75}V_{0.25}O₄ | 2.11 | 1.21 | 99.9 |
| C1 | LiZnVO₄ | 0.52 | 1.27 | 94.0 |
| C2 | LiZnPO₄ | 1.22 | 1.30 | 95.4 |

As shown in Table 3, in all the evaluation cells, the average charge potential (redox potential of the active material) Vc of the negative electrode on the basis of Li metal was higher than 0 V and lower than or equal to 1.5 V. Therefore, it has been confirmed that the deposition of lithium metal in the negative electrode is suppressed and that a high energy density is guaranteed.

The discharge capacitances of the evaluation cells were compared. The discharge capacitance at the second cycle of each of evaluation cells A1 through A3 was found to be higher than that of each of evaluation cells C1 and C2. The coulombic efficiency at the tenth cycle of each of evaluation cells A1 through A3 was also found to be higher than that of each of evaluation cells C1 and C2. Conceivable reasons for this are as follows. Regarding evaluation cell C1, the crystal breakage of active material c1 of the negative electrode occurred. In evaluation cell C2, the crystal breakage was suppressed. A conceivable reason why evaluation cell C2 did not obtain a high coulombic efficiency is that the gap e in the Cc structure of active material c2 did not allow desorption/insertion of lithium ions as easily as the gap e in the R3 structure (see FIGS. 2(a) and (b)) or that many lithium ions were made irreversible at the time of charge. It has been further found that when the value of x in the composition formula of the active material is larger than or equal to 0.05 and smaller than or equal to 0.75 (evaluation cells A1 through A3), the deterioration of the crystal, which would be caused by a crystal structure change, can be suppressed more effectively while a certain capacitance per weight is guaranteed. Especially when the value of x was larger than or equal to 0.5 and smaller than or equal to 0.75 (evaluation cells A2 and A3), the effect of substituting the V atoms with the P atoms was improved and a higher discharge capacitance was provided.

### (viii) Analysis on the Electrodes after the Charge/Discharge Cycle Test

After the above-described charge/discharge cycle test was finished, the active material of each evaluation cell was analyzed by XRD.

First, evaluation cells A1 through A3 and C1 in a discharged state after the tenth cycle were each disassembled and the electrode was removed. The removed electrode was sufficiently washed with ethylmethylcarbonate and subjected to an XRD measurement.

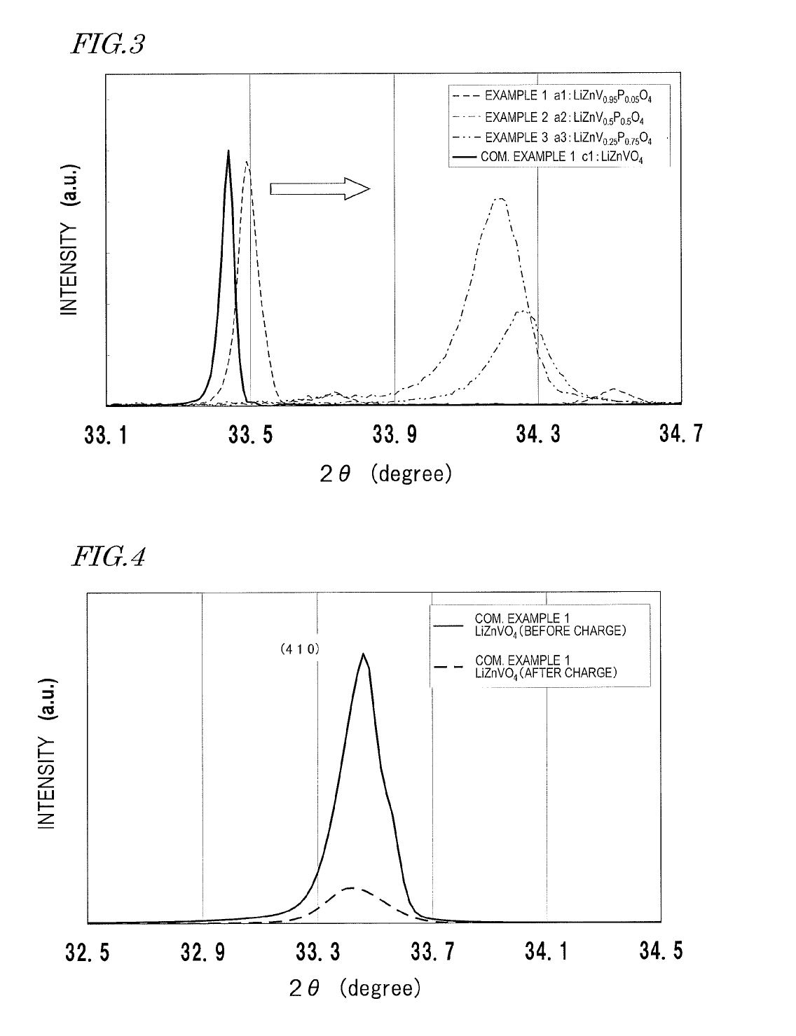

FIG. 4 shows x-ray diffraction patterns obtained by the XRD measurement. FIG. 4 also shows x-ray diffraction patterns of the active materials a1 through a3 before the charge/discharge cycle test for comparison.

As can be seen from the x-ray diffraction patterns FIG. 4, the electrodes in examples 1 through 3 have all the peaks derived from active materials a1 through a3, respectively. Therefore, it has been confirmed that the crystal structure of each of active material a1 through a3 was maintained even after the charge/discharge cycle test. By contrast, in the case of the electrode of comparative example 1, the peaks derived from active material c1 are mostly extinguished. Based on this, it is considered that in comparative example 1, the crystal structure of active material c1 was broken due to the repeated charge/discharge. Regarding the electrode in comparative example 2, the x-ray diffraction pattern after the charge/discharge cycle test is not shown. Nonetheless, from the results in Table 3, it is considered that the crystal structure (Cc structure) of active material c2 was maintained even after the charge/discharge cycle test.

As described above, use of an active material in an embodiment according to the present invention suppresses the breakage of the crystal structure, which would be caused by the desorption/insertion of lithium ions at the time of charge/discharge. Therefore, a lithium ion secondary battery which can suppress the deposition of lithium metal and has a high energy density and also a high reliability can be provided.

### INDUSTRIAL APPLICABILITY

An active material for a lithium ion secondary battery in an embodiment according to the present invention, and a lithium ion secondary battery containing such an active material, are usable for, for example, a power source of devices used in the field of environmental energy, for example, power storage devices, electric vehicles and the like. The active material and the lithium ion secondary battery are also usable for a power source of mobile electronic devices such as personal computers, mobile phones, mobile devices, personal data assistants (PDAs), mobile game devices, video cameras and the like. The active material and the lithium ion secondary battery are also expected to be usable for a secondary battery assisting an electric motor in hybrid electric vehicles, fuel cell vehicles and the like; for a driving power source of electric tools, vacuum cleaners, robots and the like; for a power source of plug-in HEVs; and the like.

### REFERENCE SIGNS LIST

2 Sealing plate
3 Battery case
4 Negative electrode
5 Positive electrode
6 Separator
7 Gasket
100 Lithium ion secondary battery

1. An active material for a lithium ion secondary battery, the active material having a composition represented by LiZnP₍ₓ₎V₍₁₋ₓ₎O₄ (O<x<1) and having a redox potential that is higher than 0 V and lower than or equal to 1.5 V on a lithium metal basis.

2. The active material for a lithium ion secondary battery of claim 1, wherein the active material has a crystal structure in which a P atom and a V atom share the same site.

3. The active material for a lithium ion secondary battery of claim 1, wherein:
the active material is capable of occluding and releasing lithium ions; and
the active material has a crystal structure of a trigonal system, in a state that the lithium ions are released from the active material.

4. The active material for a lithium ion secondary battery of claim 3, wherein in a state that the lithium ions are released from the active material, at least a part of the crystal structure has a space group including three-fold rotation operation or three-fold rotoinversion operation.

5. The active material for a lithium ion secondary battery of claim 3, wherein in a state that the lithium ions are released from the active material, at least a part of the crystal structure has a space group of:
R 3̅ or R3. [Expression 1]

6. The active material for a lithium ion secondary battery of claim 1, wherein x in the composition of the active material fulfills 0.05≦x≦0.75.

7. A lithium ion secondary battery, comprising:
a positive electrode containing a positive electrode active material capable of occluding and releasing lithium ions;
a negative electrode containing an active material of claim 1;
a separator located between the positive electrode and the negative electrode; and
an electrolyte having a lithium ion conductivity.
